(19) United States
(12) Patent Application Publication
(10) Pub. No.: US 2024/0306188 A1
(43) Pub. Date: Sep. 12, 2024

(54) SYSTEM AND METHOD FOR ADAPTIVE DCI RAR OPTIMIZATION

(71) Applicant: RAKUTEN MOBILE, INC., Tokyo (JP)

(72) Inventor: Sandeep Mani TRIPATHI, Tokyo (JP)

(73) Assignee: RAKUTEN MOBILE, INC., Tokyo (JP)

(21) Appl. No.: 18/010,344

(22) PCT Filed: Oct. 12, 2022
(86) PCT No.: PCT/US2022/046359

§ 371 Date: Dec. 14, 2022

(51) Int. Cl. H04W 74/00; H04W 74/0833

(52) U.S. Cl. CPC H04W 74/006; H04W 74/0833

(57) ABSTRACT

An apparatus and method for optimizing an aggregation level for communicating physical downlink shared channel (PDSCH) resources in a random access network (RAN) are provided. The apparatus includes a memory storing instructions; and at least one processor configured to execute the instructions to: receive, by a radio access network (RAN) node, a random access request message from a user equipment (UE); determine, by the RAN node, a signal-to-interference-plus-noise ratio (SINR) of the first random access request message; compare the SINR with a first predetermined threshold; based on the comparing, determining an aggregation level from among a plurality of predetermined aggregation levels; and transmit a random access response message from the RAN node to the UE based on the determined aggregation level.

### TECHNICAL FIELD

Apparatuses and methods consistent with example embodiments of the present disclosure relate to optimizing an aggregation level for communicating physical downlink shared channel (PDSCH) resources in a random access network (RAN).

### BACKGROUND

In related art communication standards (e.g., 4G/LTE and 5G standards), during initial access and handover of a user equipment (UE) in a radio access network (RAN), the UE uses a contention-free random access (CFRA) or a contention-based random access (CBRA) preamble to access the network. In particular, during a Random Access Procedure (RACH) (e.g., during the exchange of four messages Msg1 to Msg4 of a CBRA procedure or two messages Msg1 to Msg2 of a CFRA procedure) between the UE and the RAN node, the RAN node (e.g., eNB or gNB) uses an aggregation level from among a plurality of predetermined aggregation levels (e.g., Agg2, Agg4, Agg8, and/or Agg16) to communicate msg2 PDSCH resources to the UE. To this end, the set aggregation level indicates how many control channel elements (CCEs) are allocated to carry a physical downlink control channel (PDCCH) Downlink Control Information (DCI) message that communicates PDSCH resources to the UE (e.g., schedules/allocates PDSCH resources to the UE).

Notably, in the related art, the aggregation level is fixed in a particular network; that is, the same value for the aggregation level is constantly used for msg2 DCI by the network. As a result, in the case of good radio frequency (RF) conditions (i.e., a high coverage/quality area), a predetermined aggregation level leads to more resources than necessary being used, i.e., an inefficient use of resources. However, in the case of poor RF conditions (i.e., a low coverage/quality area), the fixed aggregation level leads to deficient resources and a high DCI decoding failure at the UE.

### SUMMARY

According to embodiments, systems and methods are provided for optimizing resources to communicate a downlink control information (DCI) message in a random access response (RAR) by dynamically determining an aggregation level at a RAN node. The systems and methods enable the RAN node to determine an aggregation level value from among a plurality of predetermined aggregation levels based on a signal-to-interference-plus-noise ratio (SINR) of the first random access request message from the UE.

According to embodiments, a method for optimizing an aggregation level for communicating physical downlink shared channel (PDSCH) resources in a random access network (RAN), includes: receiving, by a radio access network (RAN) node, a random access request message from a user equipment (UE); determining, by the RAN node, a signal-to-interference-plus-noise ratio (SINR) of the first random access request message; comparing the SINR with a first predetermined threshold; based on the comparing, determining an aggregation level from among a plurality of predetermined aggregation levels; and transmitting a random access response message from the RAN node to the UE based on the determined aggregation level.

The determining comprises: determining, as the aggregation level, a first predetermined aggregation level from among the plurality of predetermined aggregation levels, based on the SINR being equal to or greater than the first predetermined threshold; and determining, as the aggregation level, a second predetermined aggregation level from among the plurality of predetermined aggregation levels, based on the SINR being less than the first predetermined threshold.

The second predetermined aggregation level is greater than the first predetermined aggregation level.

The method may further include comparing the SINR with a second predetermined threshold, wherein the step of determining may include determining the aggregation level based on the comparing with the first predetermined threshold and the comparing with the second predetermined threshold.

The determining based on the comparing with the first predetermined threshold and the comparing with the second predetermined threshold may include: determining, as the aggregation level, a first predetermined aggregation level from among the plurality of predetermined aggregation levels, based on the SINR being equal to or greater than the first predetermined threshold; determining, as the aggregation level, a second predetermined aggregation level from among the plurality of predetermined aggregation levels, based on the SINR being less than the first predetermined threshold and equal to or greater than the second predetermined threshold; and determining, as the aggregation level, a third predetermined aggregation level from among the plurality of predetermined aggregation levels, based on the SINR being less than the second predetermined threshold.

The second predetermined aggregation level is greater than the first predetermined aggregation level, and the third predetermined aggregation level is greater than the second predetermined aggregation level.

The random access response message is a physical downlink control channel (PDCCH) message.

According to the embodiments, an apparatus for optimizing an aggregation level for communicating physical downlink shared channel (PDSCH) resources in a random access network (RAN), includes: a memory storing instructions; and at least one processor configured to execute the instructions to: receive, by a radio access network (RAN) node, a random access request message from a user equipment (UE); determine, by the RAN node, a signal-to-interference-plus-noise ratio (SINR) of the first random access request message; compare the SINR with a first predetermined threshold; based on the comparing, determining an aggregation level from among a plurality of predetermined aggregation levels; and transmit a random access response message from the RAN node to the UE based on the determined aggregation level.

The at least one processor is configured to further execute instructions to: determine, as the aggregation level, a first predetermined aggregation level from among the plurality of predetermined aggregation levels, based on the SINR being equal to or greater than the first predetermined threshold; and determine, as the aggregation level, a second predetermined aggregation level from among the plurality of predetermined aggregation levels, based on the SINR being less than the first predetermined threshold.

The at least one processor is configured to further execute instructions to: compare the SINR with a second predetermined threshold, and determine a third predetermined aggregation level, wherein the determining comprises determining the aggregation level based on the comparing with the first predetermined threshold and the comparing with the second predetermined threshold.

The at least one processor is configured to further execute instructions to: determine, as the aggregation level, a first predetermined aggregation level from among the plurality of predetermined aggregation levels, based on the SINR being equal to or greater than the first predetermined threshold; determine, as the aggregation level, a second predetermined aggregation level from among the plurality of predetermined aggregation levels, based on the SINR being less than the first predetermined threshold and equal to or greater than the second predetermined threshold; and determine, as the aggregation level, the third predetermined aggregation level from among the plurality of predetermined aggregation levels, based on the SINR being less than the second predetermined threshold.

The second predetermined aggregation level is greater than the first predetermined aggregation level, and the third predetermined aggregation level is greater than the second predetermined aggregation level.

According to an embodiment, a non-transitory computer-readable medium stores computer readable program code or instructions for carrying out operations, when executed by a processor, for optimizing an aggregation level for communicating physical downlink shared channel (PDSCH) resources in a random access network (RAN), the operations including: receiving, by a radio access network (RAN) node, a random access request message from a user equipment (UE); determining, by the RAN node, a signal-to-interference-plus-noise ratio (SINR) of the first random access request message; comparing the SINR with a first predetermined threshold; based on the comparing, determining an aggregation level from among a plurality of predetermined aggregation levels; and transmitting a random access response message from the RAN node to the UE based on the determined aggregation level.

The determining operation comprises: determining, as the aggregation level, a first predetermined aggregation level from among the plurality of predetermined aggregation levels, based on the SINR being equal to or greater than the first predetermined threshold; and determining, as the aggregation level, a second predetermined aggregation level from among the plurality of predetermined aggregation levels, based on the SINR being less than the first predetermined threshold.

The second predetermined aggregation level is greater than the first predetermined aggregation level.

The operation may further include: comparing the SINR with a second predetermined threshold, wherein the determining comprises determining the aggregation level based on the comparing with the first predetermined threshold and the comparing with the second predetermined threshold.

The determining operation based on the comparing with the first predetermined threshold and the comparing with the second predetermined threshold comprises: determining, as the aggregation level, a first predetermined aggregation level from among the plurality of predetermined aggregation levels, based on the SINR being equal to or greater than the first predetermined threshold; determining, as the aggregation level, a second predetermined aggregation level from among the plurality of predetermined aggregation levels, based on the SINR being less than the first predetermined threshold and equal to or greater than the second predetermined threshold; and determining, as the aggregation level, a third predetermined aggregation level from among the plurality of predetermined aggregation levels, based on the SINR being less than the second predetermined threshold.

The second predetermined aggregation level is greater than the first predetermined aggregation level, and the third predetermined aggregation level is greater than the second predetermined aggregation level.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an embodiment;

FIG. 2A illustrates a RACH Contention Based Random Access (CBRA) procedure according to an embodiment;

FIG. 2B illustrates a RACH Contention Free Random Access (CFRA) procedure according to an embodiment;

FIG. 3 illustrates a method for determining an aggregation level in a RAN according to an embodiment;

FIG. 4 illustrates a method for determining an aggregation level in a RAN according to another embodiment;

FIG. 5 illustrates a method for determining an aggregation level in a RAN according to another embodiment;

FIG. 6 illustrates a method for determining an aggregation level in a RAN according to another embodiment; and

FIG. 7 illustrates a method for determining an aggregation level in a RAN according to another embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which an aggregation level is determined based on at least one threshold comparison between a SINR received from the RAN (i.e., obtained from a random access request message sent from an UE and measured at a base station) and at least one predetermined threshold.

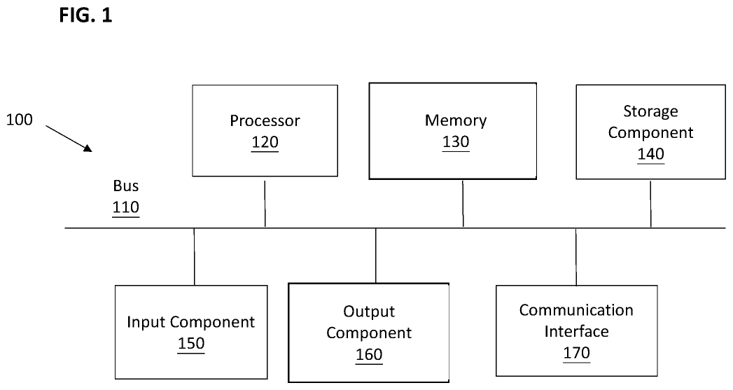

FIG. 1 is a diagram of example components of a device 100. Device 100 may correspond to user device 110 and/or platform 120. As shown in FIG. 1, device 100 may include a bus 110, a processor 120, a memory 130, a storage component 140, an input component 150, an output component 160, and a communication interface 170.

Bus 110 includes a component that permits communication among the components of device 100. Processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 120 includes one or more processors capable of being programmed to perform a function. Memory 130 includes a random access memory (RAM), a read only memory (ROM), and/or another type of dynamic or static storage device (e.g., a flash memory, a magnetic memory, and/or an optical memory) that stores information and/or instructions for use by processor 120.

Storage component 140 stores information and/or software related to the operation and use of device 100. For example, storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from device 100 (e.g., a display, a speaker, and/or one or more light-emitting diodes (LEDs)).

Communication interface 170 includes a transceiver-like component (e.g., a transceiver and/or a separate receiver and transmitter) that enables device 100 to communicate with other devices, such as via a wired connection, a wireless connection, or a combination of wired and wireless connections. Communication interface 170 may permit device 100 to receive information from another device and/or provide information to another device. For example, communication interface 170 may include an Ethernet interface, an optical interface, a coaxial interface, an infrared interface, a radio frequency (RF) interface, a universal serial bus (USB) interface, a Wi-Fi interface, a cellular network interface, or the like. Device 100 may perform one or more processes described herein. Device 100 may perform these processes in response to processor 120 executing software instructions stored by a non-transitory computer-readable medium, such as memory 130 and/or storage component 140. A computer-readable medium is defined herein as a non-transitory memory device. A memory device includes memory space within a single physical storage device or memory space spread across multiple physical storage devices.

Software instructions may be read into memory 130 and/or storage component 140 from another computer-readable medium or from another device via communication interface 170. When executed, software instructions stored in memory 130 and/or storage component 140 may cause processor 120 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 1 are provided as an example. In practice, device 100 may include additional components, fewer components, different components, or differently arranged components than those shown in FIG. 1. Additionally, or alternatively, a set of components (e.g., one or more components) of device 100 may perform one or more functions described as being performed by another set of components of device 100.

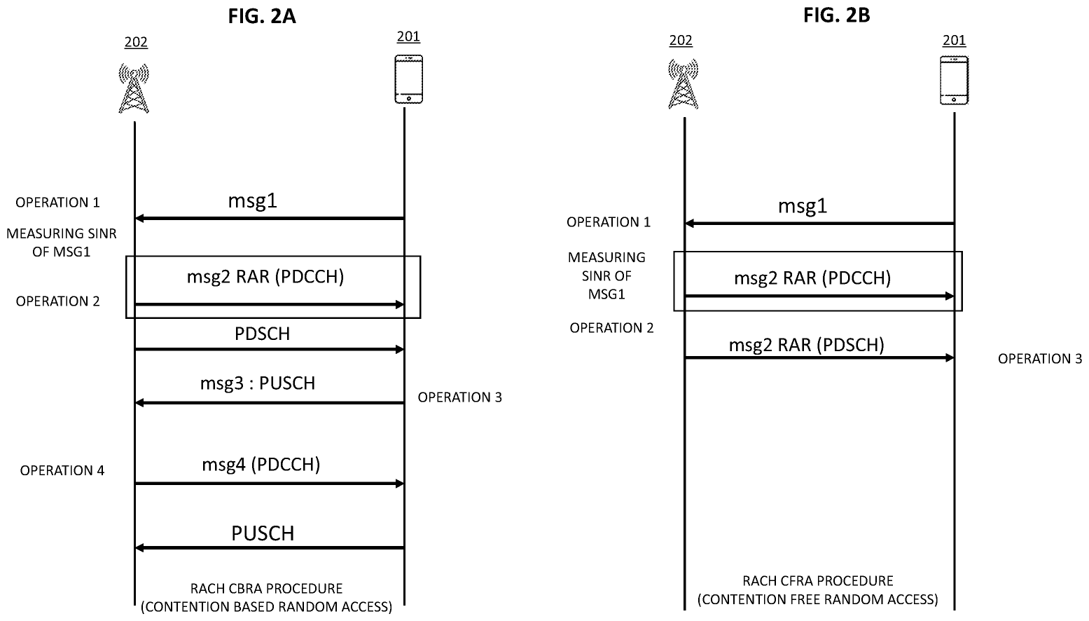

In embodiments, any one of the operations or processes of FIGS. 2 to 7 may be implemented by using any one of the elements illustrated in FIG. 1.

FIG. 2A illustrates a RACH Contention Based Random Access (CBRA) procedure according to an embodiment. Referring to FIG. 2A, in a first operation, the UE 201 transmits a random access request transmission (i.e., a random access request Msg1) to the base station 202 (i.e., the RAN node). Upon receiving the random access request Msg1, the RAN node measures uplink SINR based thereon.

In a second operation, the base station 202 compares the SINR with a first predetermined threshold, determines an aggregation level from among a plurality of predetermined aggregation levels based on the comparing and transmits a random access response message from the RAN node to the UE based on the determined aggregation level. For example, when transmitting the random access response Msg2 via the physical downlink control channel (PDCCH), the base station 202 uses the determined aggregation level to communicate DCI. The UE 201 monitors the PDCCH and waits for the random access response Msg2.

In a third operation, upon receiving the random access response Msg2 from the base station 202, the UE 201 transmits an uplink UL scheduled transmission Msg3 over the physical uplink shared channel (PUSCH).

In a fourth operation, upon receiving the uplink UL scheduled transmission Msg3 from the UE 201, the base station 202 transmits a contention resolution message Msg4 to the UE.

In an example embodiment, in case the UE 201 does not receive the DCI in the random access response Msg2 on the PDCCH within a predetermined random access response window or fails to verify the response (e.g., fails to successfully decode DCI), the response fails. In this case, if the number of random access (RA) attempts is smaller than an upper limit, and the UE retries an RA by resending a random access request Msg1 to the base station 202. In this case, the base station may re-measure the SINR of the random access request message Msg1, again determine an aggregation level from among plural predetermined aggregation levels, and re-send the DCI via the PDCCH using the determined aggregation level (i.e., the base station may repeat the determining of the aggregation level for transmitting DCI to the UE).

FIG. 2B illustrates a RACH contention-free random access CFRA procedure according to an embodiment. Referring to FIG. 2B, in a first operation, the UE 201 transmits a random access request transmission (i.e., a random access request Msg1) to the base station 202 (i.e., the RAN node). Upon receiving the random access request Msg1, the base station 202 measures uplink SINR based thereon.

In a second operation, the base station 202 compares the SINR with a first predetermined threshold, determines an aggregation level from among a plurality of predetermined aggregation levels based on the comparing and transmits a random access response message from the base station 202 (i.e., the RAN node) to the UE 201 based on the determined aggregation level. For example, when transmitting the random access response Msg2 via the physical downlink control channel PDCCH, the base station 202 uses the determined aggregation level to communicate DCI. The UE 201 monitors the PDCCH and waits for the random access response Msg2.

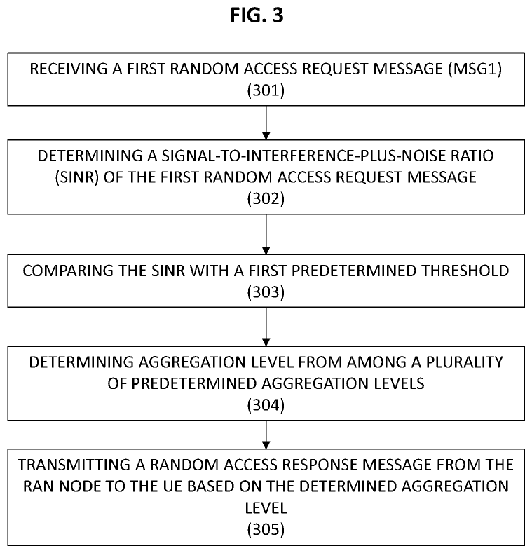

FIG. 3 illustrates a method for adaptively determining an aggregation level in a RAN according to an embodiment. Referring to FIG. 3, in step 301 a base station (i.e., a radio access network (RAN) node) receives a first random access request message (i.e., an access request message Msg1) from a UE.

In step 302, the base station (i.e., the RAN node) determines uplink SINR based on the first random access request message Msg1.

In step 303, the base station compares the SINR with a first predetermined threshold.

In step 304, based on the comparison, the base station determines an aggregation level from among a plurality of predetermined aggregation levels.

In step 305, the base station 202 (i.e., RAN node) transmits the DCI on the PDCCH, according to the determined aggregation level, via the random access response message Msg2 from the RAN node to the UE.

As a result, the base station adaptively determines an aggregation level value from among a plurality of predetermined aggregation levels. This determination of the aggregation level is based on and adaptive to the actual quality of a radio link between the UE and the RAN node, thereby enabling a more efficient use of available resources and improving the msg2 DCI decoding success rate.

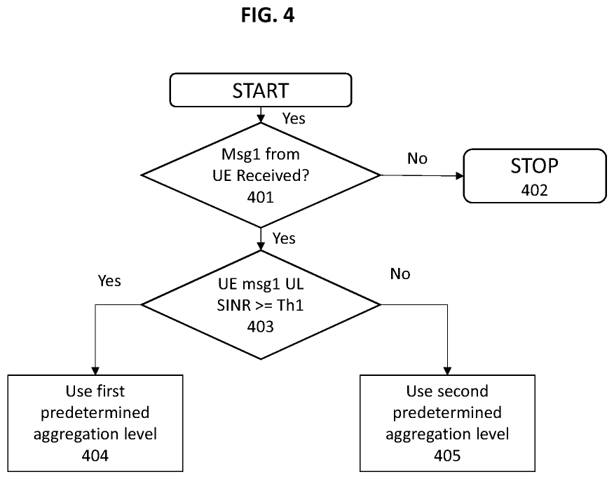

FIG. 4 illustrates a method for dynamically determining an aggregation level in a RAN according to another embodiment. Referring to FIG. 4, in step 401, the base station (i.e., the RAN node) checks whether a first random access request message Msg1 is received from a UE.

In step 402, if the base station has not received Msg1 from the UE (No in step 401), the method ends (or the base station waits until Msg1 is received).

In step 403, if the first random access request message Msg1 is received from the UE (Yes in step 401), the base station determines (e.g., measures) the SINR of the access request message Msg1 and compares the SINR with a first predetermined threshold. In example embodiments described herein, the uplink SINR is determined and used as a basis for selecting an aggregation level. It is understood, however, that other embodiments may not be limited thereto. For example, another metric or parameter may be used to determine a radio condition between the UE and the base station, and the determined radio condition may be used as a basis for selecting the aggregation level.

In step 404, in case the base station determines that the SINR is equal to or greater than the first threshold (Yes in step 403), the base station determines a first aggregation level, from among plural predetermined aggregation levels, based on the comparison. Here, the plurality of predetermined aggregation levels may be standardized aggregation levels (e.g., Agg1, Agg2, Agg4, Agg8, Agg16).

In step 405, in case the base station determines that the SINR is less than the first threshold (No in step 403), the base station determines a second aggregation level, from among plural predetermined aggregation levels, based on the comparison.

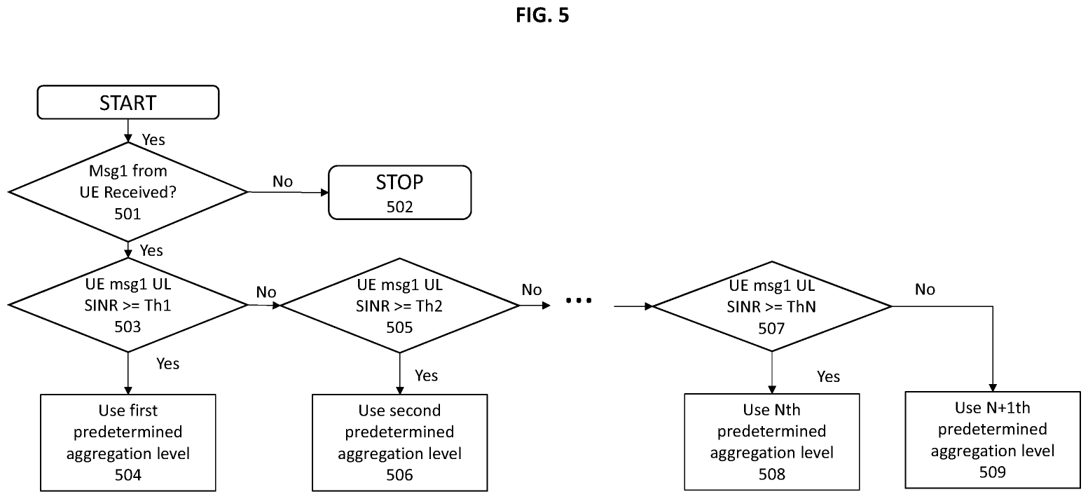

FIG. 5 illustrates a method for determining an aggregation level in a RAN according to another embodiment. Referring to FIG. 5, in step 501, the base station checks whether it received a first random access request message from a UE.

In step 502, similar to step 402 of FIG. 4, the base station ends the process if no first random access request message was received from a UE.

In step 503, in case the base station determines that it has received the first random access request message Msg1 from the UE (Yes in step 501), the base station determines the SINR of the first random access request message Msg1 and compares the SINR with a first predetermined threshold.

In step 504, in case the base station determines that the SINR is equal to or greater than the first threshold (Yes in step 503), the base station determines a first aggregation level from among a plurality of predetermined aggregation levels.

In step 505, in case the base station determines that the SINR is smaller than the first threshold (No in step 503), the base station compares the SINR with a second predetermined threshold.

In step 506, in case the base station determines that the SINR is equal to or greater than the second threshold (Yes in step 505), the base station determines a second aggregation level from among the plurality of predetermined aggregation levels.

In one example embodiment, the method for determining an aggregation level may include N number of threshold comparisons. According to this embodiment, in step 507, in case the base station determines that the SINR is smaller than an N−1th predetermined threshold (e.g., a second threshold), the base station compares the SINR with an Nth predetermined threshold (e.g., a third threshold).

In step 508, in case the base station determines that the SINR is equal to or greater than the Nth threshold (Yes in step 507), the base station determines the Nth aggregation level from among the plurality of predetermined aggregation levels.

In step 509, in case the base station determines that the SINR is less than the predetermined Nth threshold (No in step 507), the base station determines the N+1th aggregation level from among a plurality of predetermined aggregation levels based on the determining. For example, the plurality of predetermined aggregation levels may include Agg2, Agg4, Agg8 and/or Agg16.

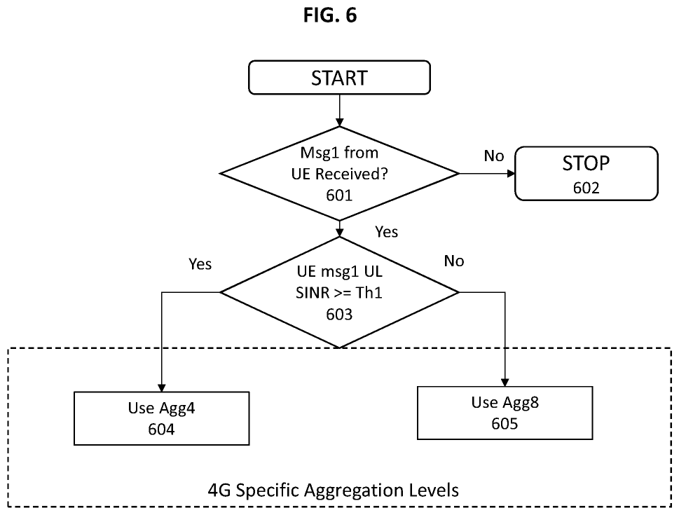

FIG. 6 illustrates a method for determining an aggregation level in a RAN according to another embodiment. The embodiment of FIG. 6 may be applicable to a 4G/LTE radio access network, and may be performed by an eNB. Referring to FIG. 6, in step 601, the base station (e.g., eNB) checks whether the first random access request message Msg1 is received from a UE.

In step 602, the base station ends the process if no first random access request message is received from a UE (No in step 601) (or the base station waits until the first random access request message is received).

In step 603, in case the base station determines that the first random access request message Msg1 is received from a UE (Yes in step 601), the base station determines the SINR of the first random access request message Msg1 and compares the SINR with the first predetermined threshold.

In step 604, in case the base station determines that the SINR is equal to or greater than the first threshold (Yes in step 603), the base station determines a first aggregation level Agg4 from among a plurality of predetermined aggregation levels. For example, the plurality of predetermined aggregation levels may include Agg4 and Agg8 in accordance with LTE communication standards.

In step 605, if the base station determines that the SINR is less than the first threshold (No in step 603), the base station determines a second aggregation level Agg8 from among a plurality of predetermined aggregation levels.

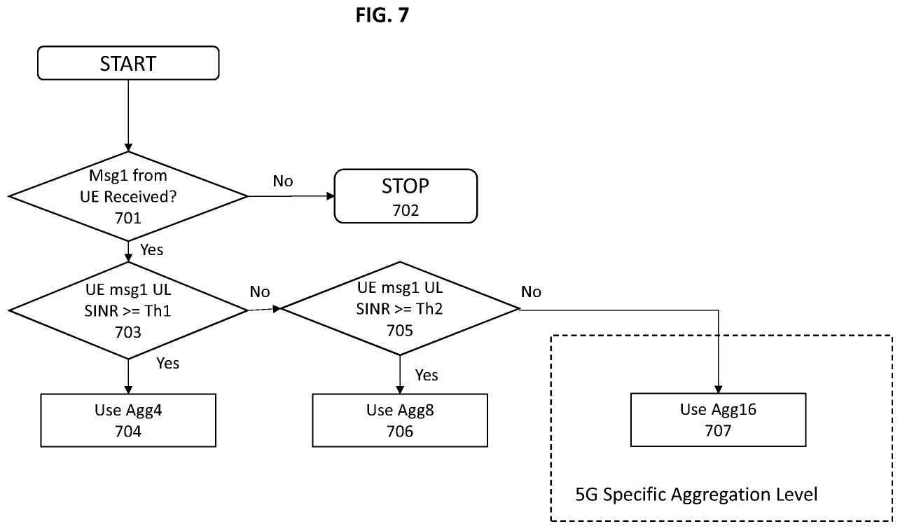

FIG. 7 illustrates a method for determining an aggregation level in a RAN according to another embodiment. The embodiment of FIG. 7 may be applicable to a 5G radio access network, and may be performed by a gNB. Referring to FIG. 7, steps 701 to 705 are similar to steps 501 to 505 of FIG. 5.

However, in step 704, in case the base station determines that the SINR is equal to or greater than the first threshold (Yes in step 503), the base station determines the first predetermined aggregation level Agg4.

In step 706, in case the base station determines that the SINR is greater than or equal to the second threshold (Yes in step 705), the base station determines a second aggregation level Agg8 from among a plurality of predetermined aggregation levels. For example, the plurality of predetermined aggregation levels may include Agg4, Agg8, and Agg16 in accordance with 5G communication standards.

In step 707, in case the base station determines that the SINR is less than the second threshold (No in step 705), the base station determines a third aggregation level Agg16 from among a plurality of predetermined aggregation levels.

According to example embodiments, the RAN node adaptively determines an aggregation level to use for communicating DCI over a PDCCH, based on a radio condition between the UE and the RAN node (e.g., based on an uplink SINR). As a result, radio resources may be efficiently allocated and used, and failures in DCI decoding at the UE may be reduced.

The foregoing disclosure provides illustration and description, but is not intended to be exhaustive or to limit the implementations to the precise form disclosed. Modifications and variations are possible in light of the above disclosure or may be acquired from practice of the implementations.

Moreover, it is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

1. A method for optimizing an aggregation level for communicating physical downlink shared channel (PDSCH) resources in a random access network (RAN), the method comprising:
receiving, by a radio access network (RAN) node, a random access request message from a user equipment (UE);
determining, by the RAN node, a signal-to-interference-plus-noise ratio (SINR) of the first random access request message;
comparing the SINR with a first predetermined threshold;
based on the comparing, determining an aggregation level from among a plurality of predetermined aggregation levels; and
transmitting a random access response message from the RAN node to the UE based on the determined aggregation level.

2. The method of claim 1, wherein the determining comprises:
determining, as the aggregation level, a first predetermined aggregation level from among the plurality of predetermined aggregation levels, based on the SINR being equal to or greater than the first predetermined threshold; and
determining, as the aggregation level, a second predetermined aggregation level from among the plurality of predetermined aggregation levels, based on the SINR being less than the first predetermined threshold.

3. The method of claim 2, wherein the second predetermined aggregation level is greater than the first predetermined aggregation level.

4. The method of claim 1, further comprising:
comparing the SINR with a second predetermined threshold,
wherein the determining comprises determining the aggregation level based on the comparing with the first predetermined threshold and the comparing with the second predetermined threshold.

5. The method of claim 4, wherein the determining based on the comparing with the first predetermined threshold and the comparing with the second predetermined threshold comprises:
determining, as the aggregation level, a first predetermined aggregation level from among the plurality of predetermined aggregation levels, based on the SINR being equal to or greater than the first predetermined threshold;
determining, as the aggregation level, a second predetermined aggregation level from among the plurality of predetermined aggregation levels, based on the SINR being less than the first predetermined threshold and equal to or greater than the second predetermined threshold; and
determining, as the aggregation level, a third predetermined aggregation level from among the plurality of predetermined aggregation levels, based on the SINR being less than the second predetermined threshold.

6. The method of claim 5, wherein the second predetermined aggregation level is greater than the first predetermined aggregation level, and the third predetermined aggregation level is greater than the second predetermined aggregation level.

7. The method of claim 1, wherein the random access response message is a physical downlink control channel (PDCCH) message.

8. An apparatus for optimizing an aggregation level for communicating physical downlink shared channel (PDSCH) resources in a random access network (RAN), the apparatus comprising:
a memory storing instructions; and
at least one processor configured to execute the instructions to:
receive, by a radio access network (RAN) node, a random access request message from a user equipment (UE);
determine, by the RAN node, a signal-to-interference-plus-noise ratio (SINR) of the first random access request message;
compare the SINR with a first predetermined threshold;
based on the comparing, determining an aggregation level from among a plurality of predetermined aggregation levels; and
transmit a random access response message from the RAN node to the UE based on the determined aggregation level.

9. The apparatus of claim 8, wherein the at least one processor is configured to further execute instructions to:
determine, as the aggregation level, a first predetermined aggregation level from among the plurality of predetermined aggregation levels, based on the SINR being equal to or greater than the first predetermined threshold; and
determine, as the aggregation level, a second predetermined aggregation level from among the plurality of predetermined aggregation levels, based on the SINR being less than the first predetermined threshold,
wherein the second predetermined aggregation level is greater than the first predetermined aggregation level.

9. (canceled)

10. The apparatus of claim 9, wherein the at least one processor is configured to further execute instructions to:
compare the SINR with a second predetermined threshold, and
determine a third predetermined aggregation level,
wherein the determining comprises determining the aggregation level based on the comparing with the first predetermined threshold and the comparing with the second predetermined threshold.

11. The apparatus of claim 10, wherein the at least one processor is configured to further execute instructions to:
determine, as the aggregation level, a first predetermined aggregation level from among the plurality of predetermined aggregation levels, based on the SINR being equal to or greater than the first predetermined threshold;
determine, as the aggregation level, a second predetermined aggregation level from among the plurality of predetermined aggregation levels, based on the SINR being less than the first predetermined threshold and equal to or greater than the second predetermined threshold; and
determine, as the aggregation level, the third predetermined aggregation level from among the plurality of predetermined aggregation levels, based on the SINR being less than the second predetermined threshold.

12. The apparatus of claim 11, wherein the second predetermined aggregation level is greater than the first predetermined aggregation level, and the third predetermined aggregation level is greater than the second predetermined aggregation level.

13. The apparatus of claim 8, wherein the random access response message is a physical downlink control channel (PDCCH) message.

14. A non-transitory computer-readable medium for storing computer readable program code or instructions for carrying out operations, when executed by a processor, for optimizing an aggregation level for communicating physical downlink shared channel (PDSCH) resources in a random access network (RAN), the operations comprising:
receiving, by a radio access network (RAN) node, a random access request message from a user equipment (UE);
determining, by the RAN node, a signal-to-interference-plus-noise ratio (SINR) of the first random access request message;
comparing the SINR with a first predetermined threshold;
based on the comparing, determining an aggregation level from among a plurality of predetermined aggregation levels; and
transmitting a random access response message from the RAN node to the UE based on the determined aggregation level.

15. The non-transitory computer-readable medium of claim 14, wherein the determining comprises:
determining, as the aggregation level, a first predetermined aggregation level from among the plurality of predetermined aggregation levels, based on the SINR being equal to or greater than the first predetermined threshold; and
determining, as the aggregation level, a second predetermined aggregation level from among the plurality of predetermined aggregation levels, based on the SINR being less than the first predetermined threshold.

16. The non-transitory computer-readable medium of claim 15, wherein the second predetermined aggregation level is greater than the first predetermined aggregation level.

17. The non-transitory computer-readable medium of claim 14, the operations further comprising:
comparing the SINR with a second predetermined threshold,
wherein the determining comprises determining the aggregation level based on the comparing with the first predetermined threshold and the comparing with the second predetermined threshold.

18. The non-transitory computer-readable medium of claim 17, wherein the determining based on the comparing with the first predetermined threshold and the comparing with the second predetermined threshold comprises:
determining, as the aggregation level, a first predetermined aggregation level from among the plurality of predetermined aggregation levels, based on the SINR being equal to or greater than the first predetermined threshold;
determining, as the aggregation level, a second predetermined aggregation level from among the plurality of predetermined aggregation levels, based on the SINR being less than the first predetermined threshold and equal to or greater than the second predetermined threshold; and
determining, as the aggregation level, a third predetermined aggregation level from among the plurality of predetermined aggregation levels, based on the SINR being less than the second predetermined threshold.

19. The non-transitory computer-readable medium of claim 18, wherein the second predetermined aggregation level is greater than the first predetermined aggregation level, and the third predetermined aggregation level is greater than the second predetermined aggregation level.

20. The non-transitory computer-readable medium of claim 14, wherein the random access response message is a physical downlink control channel (PDCCH) message.
